(19) United States
(12) Patent Application Publication
(10) Pub. No.: US 2021/0400711 A1
(43) Pub. Date: Dec. 23, 2021

(54) METHODS, RADIO NODES AND COMPUTER READABLE MEDIA FOR ENHANCED GRANT SKIPPING

(71) Applicant: Telefonaktiebolaget LM Ericsson (publ), Stockholm (SE)

(72) Inventors: Jinhua LIU, BEIJING (CN); Min WANG, LULEÅ (SE)

(21) Appl. No.: 17/296,576

(22) PCT Filed: Oct. 24, 2019
(86) PCT No.: PCT/CN2019/113047

§ 371 Date: May 25, 2021

(30) Foreign Application Priority Data
Dec. 29, 2018 (CN) PCT/CN2018/125445

(51) Int. Cl. H04W 72/14

(52) U.S. Cl. CPC H04W 72/14

(57) ABSTRACT

The present disclosure provides methods for enhanced grant skipping, and corresponding radio nodes. The method comprises determining whether to skip an uplink grant configured for a first link between the first radio node and a second radio node; and in response to determining to skip the uplink grant, using a radio resource corresponding to the uplink grant on a second link. The present disclosure further discloses a corresponding method which comprises receiving an indication from a first radio node connected to the third radio node to indicate a radio resource corresponding to an uplink grant configured for a first link between the first radio node and a second radio node is available to the third radio node, wherein the uplink grant is skipped by the first radio node; and scheduling the radio resource for a data transmission between the third radio node and a fourth radio node connected to the third radio node.

### TECHNICAL FIELD

The present disclosure generally relates to the technical field of telecommunication, and particularly to methods and radio nodes for enhanced grant skipping and corresponding computer readable media.

### BACKGROUND

This section is intended to provide a background to the various embodiments of the technology described in this disclosure. The description in this section may include concepts that could be pursued, but are not necessarily ones that have been previously conceived or pursued. Therefore, unless otherwise indicated herein, what is described in this section is not prior art to the description and/or claims of this disclosure and is not admitted to be prior art by the mere inclusion in this section.

For Uplink (UL) transmission, there may be two kinds of typical scheduling schemes:
Dynamic scheduling. Upon new data available for transmission and there is no UL grant available, a terminal device shall firstly transmit a Scheduling Request (SR) to a network node (e.g., g NB) using preconfigured resources of periodic occurrence. Upon reception of the SR from the terminal device, the network node allocates an UL grant to the terminal device via a Physical Downlink Control Channel (PDCCH). Upon reception of the UL grant, the terminal device prepares a Media Access Control (MAC) Protocol Data Unit (PDU), encodes the MAC PDU and maps the encoded MAC PDU to a Physical Uplink Shared Channel (PUSCH) for UL transmission. For an unlicensed operation according to such a procedure, the network node need perform Listen-Before-Talk (LBT) for the UL grant transmission, the terminal device need respective LBTs for SR and PUSCH transmissions, which means at least 3 LBTs for the network node and the terminal device are needed for a single packet transmission for the terminal device. This increases the risk of losing the channel.
Configured scheduling. The network node preconfigures radio resources of periodic occurrence for a terminal device. The terminal device may use the radio resources when there is UL data available. In such way, the terminal device may directly send PUSCH using the preconfigured radio resource without sending SR, and the network node does not need to send a specific UL grant upon each UL transmission. This means that the LBT by the terminal device for the SR transmission and the LBT for the UL grant transmission by the network node are avoided.

In future communication systems, such as New Radio (NR, which will be described below as an example), there are two types of semi-persistent scheduling schemes for UL, which are referred to as Configured Scheduling (CS) Type 1 and Type 2 respectively:
For CS Type 1, all parameters including periodicity, number of HARQ processes, Configured Scheduling-Radio Network Temporary Identity (CS-RNTI), power control parameters, time-frequency resources, MCS etc. are configured via Radio Resource Control (RRC) signaling. The configured grant is activated when the terminal device receives a RRC message to configure the CS Type 1.
For CS Type 2, a two-phase configuration procedure is applied: in phase 1, a set of parameters, such as periodicity, number of HARQ processes, CS-RNTI and power control parameters, are signaled by the network node via the RRC signaling; and in phase 2, the serving network node may conditionally determine when to activate/reactivate the configured UL grant Type 2 and convey the physical layer parameters, such as time-frequency resources and MCS, via the UL grant addressed to the CS-RNTI.

For both CS Type 1 and CS Type 2, the transmission opportunity (i.e. configured uplink grant) occurs according to the configured periodicity. The terminal device can determine the configured grant occurrence. When a terminal device determines to transmit data using a configured grant, the terminal device should further determine the HARQ process ID associated with the configured grant.

A radio node or user equipment (UE) can determine if a dynamic uplink grant or configured uplink grant can be skipped in some conditions. When grant skipping occurs, the grant is dropped without any transmission with the grant.

### SUMMARY

The grant skipping might lead to the resource wastage in some scenarios. At least some objects of the present disclosure are to provide technical solutions capable of improving resource efficiency by using radio resources of skipped uplink grants.

According to a first aspect of the present disclosure, there is provided a method performed at a first radio node. The method comprises determining whether to skip an uplink grant configured for a first link between the first radio node and a second radio node; and in response to determining to skip the uplink grant, using a radio resource corresponding to the uplink grant on a second link.

In an exemplary embodiment, the radio resource corresponding to the uplink grant comprises at least one of: time resource, frequency resource, power resource and antenna resource.

In an exemplary embodiment, the method further comprises, prior to using a resource corresponding to the uplink grant: identifying whether the first radio node is enabled to use the radio resource corresponding to the uplink grant.

In an exemplary embodiment, the determining step is performed at least a predefined time period ahead of starting of a data transmission using the radio resource corresponding to the uplink grant or during a transmission duration of the uplink grant.

In an exemplary embodiment, using a radio resource corresponding to the uplink grant on a second link comprises: scheduling the radio resource corresponding to the uplink grant for a data transmission between the first radio node and a third radio node connected to the first radio node.

In an exemplary embodiment, using a radio resource corresponding to the uplink grant on a second link further comprises: performing the data transmission with the third radio node according to the scheduled radio resource.

In an exemplary embodiment, a maximum transmission power of the data transmission from the first radio node to the third radio node is either selected to not exceed the allowed maximum uplink transmission power of the first radio node to the second radio node, or preconfigured.

In an exemplary embodiment, using a radio resource corresponding to the uplink grant on a second link further comprises: transmitting an indication to a third radio node connected to the first radio node to indicate the radio resource corresponding to the uplink grant is available to the third radio node.

In an exemplary embodiment, the uplink grant is a configured uplink grant or a dynamically scheduled uplink grant.

In an exemplary embodiment, the first radio node is one of an Integrated Access Backhaul (IAB) node in an IAB network, a relay node, a base station (BS) and a device having a Device to Device (D2D) communication with another device.

According to a second aspect of the present disclosure, there is provided a method performed at a third radio node. The method comprises: for a data transmission between a first radio node connected to the third radio node and the third radio node, being scheduled by the first radio node regarding to a radio resource corresponding to an uplink grant which is configured for a first link between the first radio node and a second radio node and skipped by the first radio node; and performing the data transmission with the first radio node according to the scheduled radio resource.

According to a third aspect of the present disclosure, there is provided a method performed at a third radio node. The method comprises: receiving an indication from a first radio node connected to the third radio node to indicate a radio resource corresponding to an uplink grant configured for a first link between the first radio node and a second radio node is available to the third radio node, wherein the uplink grant is skipped by the first radio node; and scheduling the radio resource for a data transmission between the third radio node and a fourth radio node connected to the third radio node.

In an exemplary embodiment, the method further comprises performing the data transmission with the fourth radio node according to the scheduled radio resource.

In an exemplary embodiment, a maximum transmission power of the data transmission from the third radio node to the fourth radio node is either selected to not exceed the allowed maximum uplink transmission power of the third radio node to the first radio node, or preconfigured.

In an exemplary embodiment, the method further comprises, prior to scheduling the radio resource: determining whether the radio resource is usable to the third radio node.

In an exemplary embodiment, the method further comprises transmitting an indication to the fourth radio node, to indicate the radio resource is available to the fourth radio node.

In an exemplary embodiment, the radio resource corresponding to the uplink grant comprises at least one of: time resource, frequency resource, power resource and antenna resource.

According to a fourth aspect of the present disclosure, there is provided an apparatus implemented in a first radio node. The apparatus comprises a communication interface arranged for communication, at least one processor, and a memory comprising instructions which, when executed by the at least one processor, cause the first radio node to: determine whether to skip an uplink grant configured for a first link between the first radio node and a second radio node; and in response to determining to skip the uplink grant, use a radio resource corresponding to the uplink grant on a second link.

In an exemplary embodiment, the radio resource corresponding to the uplink grant comprises at least one of: time resource, frequency resource, power resource and antenna resource.

In an exemplary embodiment, the instructions which, when executed by the at least one processor, further cause the first radio node to: identify whether the first radio node is enabled to use the radio resource corresponding to the uplink grant.

In an exemplary embodiment, the determining step is performed at least a predefined time period ahead of starting of a data transmission using the radio resource corresponding to the uplink grant or during a transmission duration of the uplink grant.

In an exemplary embodiment, the instructions which, when executed by the at least one processor, further cause the first radio node to: schedule the radio resource corresponding to the uplink grant for a data transmission between the first radio node and a third radio node connected to the first radio node.

In an exemplary embodiment, the instructions which, when executed by the at least one processor, further cause the first radio node to: perform the data transmission with the third radio node according to the scheduled radio resource.

In an exemplary embodiment, a maximum transmission power of the data transmission from the first radio node to the third radio node is either selected to not exceed the allowed maximum uplink transmission power of the first radio node to the second radio node, or preconfigured.

In an exemplary embodiment, the instructions which, when executed by the at least one processor, further cause the first radio node to: transmit an indication to a third radio node connected to the first radio node to indicate the radio resource corresponding to the uplink grant is available to the third radio node.

In an exemplary embodiment, the uplink grant is a configured uplink grant or a dynamically scheduled uplink grant.

In an exemplary embodiment, the first radio node is one of an Integrated Access Backhaul (IAB) node in an IAB network, a relay node, a base station (BS) and a device having a Device to Device (D2D) communication with another device.

According to a fifth aspect of the present disclosure, there is provided an apparatus implemented in a third radio node. The apparatus comprises a communication interface arranged for communication, at least one processor, and a memory comprising instructions which, when executed by the at least one processor, cause the third radio node to: for a data transmission between a first radio node connected to the third radio node and the third radio node, be scheduled by the first radio node regarding to a radio resource corresponding to an uplink grant which is configured for a first link between the first radio node and a second radio node and skipped by the first radio node; and perform the data transmission with the first radio node according to the scheduled radio resource.

According to a sixth aspect of the present disclosure, there is provided an apparatus implemented in a third radio node. The apparatus comprises a communication interface arranged for communication, at least one processor, and a memory comprising instructions which, when executed by the at least one processor, cause the third radio node to: receive an indication from a first radio node connected to the third radio node to indicate a radio resource corresponding to an uplink grant configured for a first link between the first radio node and a second radio node is available to the third radio node, wherein the uplink grant is skipped by the first radio node; and schedule the radio resource for a data transmission between the third radio node and a fourth radio node connected to the third radio node.

In an exemplary embodiment, the instructions which, when executed by the at least one processor, further cause the third radio node to: perform the data transmission with the fourth radio node according to the scheduled radio resource.

In an exemplary embodiment, a maximum transmission power of the data transmission from the third radio node to the fourth radio node is either selected to not exceed the allowed maximum uplink transmission power of the third radio node to the first radio node, or preconfigured.

In an exemplary embodiment, the instructions which, when executed by the at least one processor, further cause the third radio node to: determine whether the radio resource is usable to the third radio node.

In an exemplary embodiment, the instructions which, when executed by the at least one processor, further cause the third radio node to: transmit an indication to the fourth radio node, to indicate the radio resource is available to the fourth radio node.

In an exemplary embodiment, the radio resource corresponding to the uplink grant comprises at least one of: time resource, frequency resource, power resource and antenna resource.

According to a seventh aspect of the present disclosure, there is provided an apparatus implemented in a first radio node. The apparatus comprises a determining unit configured to determine whether to skip an uplink grant configured for a first link between the first radio node and a second radio node and a resource using unit configured to, in response to determining to skip the uplink grant, use a radio resource corresponding to the uplink grant on a second link.

In an exemplary embodiment, the radio resource corresponding to the uplink grant comprises at least one of: time resource, frequency resource, power resource and antenna resource.

In an exemplary embodiment, the apparatus further includes an identifying unit configured to identify whether the first radio node is enabled to use the radio resource corresponding to the uplink grant.

In an exemplary embodiment, the determining step is performed at least a predefined time period ahead of starting of a data transmission using the radio resource corresponding to the uplink grant or during a transmission duration of the uplink grant.

In an exemplary embodiment, the resource using unit includes a scheduling unit which is configured to schedule the radio resource corresponding to the uplink grant for a data transmission between the first radio node and a third radio node connected to the first radio node.

In an exemplary embodiment, the resource using unit includes a data transmitting unit which is configured to perform the data transmission with the third radio node according to the scheduled radio resource.

In an exemplary embodiment, a maximum transmission power of the data transmission from the first radio node to the third radio node is either selected to not exceed the allowed maximum uplink transmission power of the first radio node to the second radio node, or preconfigured.

In an exemplary embodiment, the resource using unit includes an indication transmitting unit 826 which is configured to transmit an indication to a third radio node connected to the first radio node to indicate the radio resource corresponding to the uplink grant is available to the third radio node.

In an exemplary embodiment, the uplink grant is a configured uplink grant or a dynamically scheduled uplink grant.

In an exemplary embodiment, the first radio node is one of an Integrated Access Backhaul (IAB) node in an IAB network, a relay node, a base station (BS) and a device having a Device to Device (D2D) communication with another device.

According to an eighth aspect of the present disclosure, there is provided an apparatus implemented in a third radio node. The apparatus comprises a scheduling unit which is configured to, for a data transmission between a first radio node connected to the third radio node and the third radio node, be scheduled by the first radio node regarding to a radio resource corresponding to an uplink grant which is configured for a first link between the first radio node and a second radio node and skipped by the first radio node; and a data transmitting unit which is configured to perform the data transmission with the first radio node according to the scheduled radio resource.

According to a ninth aspect of the present disclosure, there is provided an apparatus implemented in a third radio node. The apparatus comprises an indication receiving unit which is configured to receive an indication from a first radio node connected to the third radio node to indicate a radio resource corresponding to an uplink grant configured for a first link between the first radio node and a second radio node is available to the third radio node, wherein the uplink grant is skipped by the first radio node; and a scheduling unit which is configured to schedule the radio resource for a data transmission between the third radio node and a fourth radio node connected to the third radio node.

In an exemplary embodiment, the apparatus further includes a data transmitting unit which is configured to perform the data transmission with the fourth radio node according to the scheduled radio resource.

In an exemplary embodiment, a maximum transmission power of the data transmission from the third radio node to the fourth radio node is either selected to not exceed the allowed maximum uplink transmission power of the third radio node to the first radio node, or preconfigured.

In an exemplary embodiment, the apparatus further includes a usability determining unit which is configured to determine whether the radio resource is usable to the third radio node.

In an exemplary embodiment, the apparatus further includes an indication transmitting unit which is configured to transmit an indication to the fourth radio node, to indicate the radio resource is available to the fourth radio node.

In an exemplary embodiment, the radio resource corresponding to the uplink grant comprises at least one of: time resource, frequency resource, power resource and antenna resource.

According to an tenth aspect of the present disclosure, a computer readable storage medium having computer program instructions stored thereon, the computer program instructions, when executed by a processor in a network device, cause the network device to perform the methods for enhanced grant skipping as discussed previously.

According to an eleventh aspect of the present disclosure, a communication system is provided. The communication system includes a host computer including:

processing circuitry configured to provide user data; and a communication interface configured to forward user data to a cellular network for transmission to a UE. The UE includes a radio interface and processing circuitry. The UE's processing circuitry is configured to perform the methods according to the first to third aspects of the present disclosure.

In an exemplary embodiment, the communication system can further include the UE.

In an exemplary embodiment, the cellular network can further include a base station configured to communicate with the UE.

In an exemplary embodiment, the processing circuitry of the host computer can be configured to execute a host application, thereby providing the user data. The UE's processing circuitry can be configured to execute a client application associated with the host application.

According to a twelfth aspect of the present disclosure, a method is provided. The method is implemented in a communication system including a host computer, a base station and a UE. The method includes: at the host computer, providing user data; and at the host computer, initiating a transmission carrying the user data to the UE via a cellular network comprising the base station. The UE can perform the methods according to the first to third aspects of the present disclosure.

In an exemplary embodiment, the method can further include: at the UE, receiving the user data from the base station.

According to a thirteenth aspect of the present disclosure, a communication system is provided. The communication system includes a host computer including: a communication interface configured to receive user data originating from a transmission from a UE to a base station. The UE includes a radio interface and processing circuitry. The UE's processing circuitry is configured to: perform the methods according to the first to third aspects of the present disclosure.

In an exemplary embodiment, the communication system can further include the UE.

In an exemplary embodiment, the communication system can further include the base station. The base station can include a radio interface configured to communicate with the UE and a communication interface configured to forward to the host computer the user data carried by a transmission from the UE to the base station.

In an exemplary embodiment, the processing circuitry of the host computer can be configured to execute a host application. The UE's processing circuitry can be configured to execute a client application associated with the host application, thereby providing the user data.

In an exemplary embodiment, the processing circuitry of the host computer can be configured to execute a host application, thereby providing request data. The UE's processing circuitry can be configured to execute a client application associated with the host application, thereby providing the user data in response to the request data.

According to fourteenth aspect of the present disclosure, a method is provided. The method is implemented in a communication system including a host computer, a base station and a UE. The method includes: at the host computer, receiving user data transmitted to the base station from the UE. The UE can perform the methods according to the first to third aspects of the present disclosure.

In an exemplary embodiment, the method can further include: at the UE, providing the user data to the base station.

In an exemplary embodiment, the method can further include: at the UE, executing a client application, thereby providing the user data to be transmitted; and at the host computer, executing a host application associated with the client application.

In an exemplary embodiment, the method can further include: at the UE, executing a client application; and at the UE, receiving input data to the client application, the input data being provided at the host computer by executing a host application associated with the client application. The user data to be transmitted is provided by the client application in response to the input data.

According to a fifteenth aspect of the present disclosure, a method is provided. The method is implemented in a communication system including a host computer, a base station and a UE. The method includes: at the host computer, providing user data; and at the host computer, initiating a transmission carrying the user data to the UE via a cellular network comprising the base station. The UE can perform the methods according to the first to third aspects of the present disclosure.

In an exemplary embodiment, the method can further include: at the UE, receiving the user data from the base station.

According to a sixteenth aspect of the present disclosure, a communication system is provided. The communication system includes a host computer including a communication interface configured to receive user data originating from a transmission from a UE to a base station. The base station includes a radio interface and processing circuitry. The base station's processing circuitry is configured to perform the methods according to the first to third aspects of the present disclosure.

In an exemplary embodiment, the communication system can further include the base station.

In an exemplary embodiment, the communication system can further include the UE. The UE can be configured to communicate with the base station.

In an exemplary embodiment, the processing circuitry of the host computer can be configured to execute a host application; the UE can be configured to execute a client application associated with the host application, thereby providing the user data to be received by the host computer.

According to a seventeenth aspect of the present disclosure, a method is provided.

The method is implemented in a communication system including a host computer, a base station and a UE. The method includes: at the host computer, receiving, from the base station, user data originating from a transmission which the base station has received from the UE. The base station can perform the methods according to the first to third aspects of the present disclosure.

In an exemplary embodiment, the method can further include: at the base station, receiving the user data from the UE.

In an exemplary embodiment, the method can further include: at the base station, initiating a transmission of the received user data to the host computer.

According to the above technical solutions of the present disclosure, the uplink grant skipping behavior of a radio node is enhanced by using a radio resource corresponding to a skipped uplink grant configured for a first link, for data transmission on a second link. The resource efficiency is thus improved.

### BRIEF DESCRIPTION OF THE DRAWINGS

The objects, advantages and characteristics of the present disclosure will be more apparent, according to descriptions of preferred embodiments in connection with the drawings, on which:

FIG. 1 illustrates one example of an IAB system in which embodiments of the present disclosure may be implemented;

FIG. 2 illustrates one example of upstream backhaul links and downstream backhaul links in an IAB network;

FIG. 3 illustratively shows a flowchart of a method for enhanced grant skipping according to an exemplary embodiment of the present disclosure;

FIG. 4 shows the relation between the step of determining whether to skip an uplink grant and the starting of a data transmission using a radio resource corresponding to the uplink grant;

FIG. 5 illustratively shows a flowchart of a method of using a radio resource corresponding to an uplink grant on a second link according to an exemplary embodiment of the present disclosure;

FIG. 6 illustratively shows a flowchart of a method for enhanced grant skipping according to an exemplary embodiment of the present disclosure;

FIG. 7 illustratively shows a flowchart of a method according to an exemplary embodiment of the present disclosure;

FIG. 8 illustratively shows a schematic structure diagram of an apparatus implemented in a first radio node according to an exemplary embodiment of the present disclosure;

FIG. 9 illustratively shows a schematic structure diagram of an apparatus implemented in a first radio node according to an exemplary embodiment of the present disclosure;

FIG. 10 illustratively shows a schematic structure diagram of an apparatus implemented in a third radio node according to an exemplary embodiment of the present disclosure;

FIG. 11 illustratively shows a schematic structure diagram of an apparatus implemented in a third radio node according to an exemplary embodiment of the present disclosure;

FIG. 12 illustratively shows a schematic structure diagram of an apparatus implemented in a third radio node according to an exemplary embodiment of the present disclosure;

FIG. 13 illustratively shows a schematic structure diagram of an apparatus implemented in a third radio node according to an exemplary embodiment of the present disclosure;

FIG. 14 schematically illustrates a telecommunication network connected via an intermediate network to a host computer;

FIG. 15 is a generalized block diagram of a host computer communicating via a base station with a UE over a partially wireless connection; and

FIGS. 16-19 are flowcharts illustrating methods implemented in a communication system including a host computer, a base station and a UE.

It should be noted that throughout the drawings, same or similar reference numbers are used for indicating same or similar elements; various parts in the drawings are not drawn to scale, but only for an illustrative purpose, and thus should not be understood as any limitations and constraints on the scope of the present disclosure.

### DETAILED DESCRIPTION

Hereinafter, the principle and spirit of the present disclosure will be described with reference to illustrative embodiments. Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

References in the specification to “one embodiment,” “an embodiment,” “an example embodiment,” etc. indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terminology used herein is for the purpose of describing particular embodiments only and is not intended to be liming of exemplary embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In the following description and claims, unless defined otherwise, all technical and scientific terms used herein have the same meaning as commonly understood by one of ordinary skills in the art to which this disclosure belongs.

The techniques described herein may be used for various wireless communication networks such as CDMA, TDMA, FDMA, OFDMA, SC-FDMA, LTE and other networks developed in the future. The terms “network” and “system” are often used interchangeably. For illustration only, certain aspects of the techniques are described below for the next, i.e. the 5th generation of wireless communication network, such as NR. However, it will be appreciated by the skilled in the art that the techniques described herein may also be used for other wireless networks such as LTE and corresponding radio technologies mentioned herein as well as wireless networks and radio technologies proposed in the future.

As used herein, the term “network node” refers to a device in a wireless communication network via which a UE accesses the network and receives services therefrom. The network node refers to a base station (BS), an access point (AP), or any other suitable device in the wireless communication network. The BS may be, for example, a node B (NodeB or NB), an evolved NodeB (eNodeB or eNB), or gNB, a Remote Radio Unit (RRU), a radio header (RH), a remote radio head (RRH), a relay, a low power node such as a femto, a pico, and so forth. Yet further examples of the network node may include multi-standard radio (MSR) radio equipment such as MSR BSs, network controllers such as radio network controllers (RNCs) or base station controllers (BSCs), base transceiver stations (BTSs), transmission points, transmission nodes. More generally, however, the network node may represent any suitable device (or group of devices) capable, configured, arranged, and/or operable to enable and/or provide a UE access to the wireless communication network or to provide some service to a UE that has accessed the wireless communication network.

The term “User Equipment (UE)” refers to any end device that can access a wireless communication network and receive services therefrom. By way of example and not limitation, the User Equipment refers to an end terminal, a mobile terminal, or other suitable devices. The mobile terminal may be, for example, a Subscriber Station (SS), a Portable Subscriber Station, a Mobile Station (MS), or an Access Terminal (AT). The UE may include, but not limited to, portable computers, image capture terminal devices such as digital cameras, gaming terminal devices, music storage and playback appliances, a mobile phone, a cellular phone, a smart phone, voice over IP (VoIP) phones, wireless local loop phones, a tablet, a wearable device, a personal digital assistant (PDA), portable computers, desktop computer, image capture terminal devices such as digital cameras, gaming terminal devices, music storage and playback appliances, wearable terminal devices, vehicle-mounted wireless terminal devices, wireless endpoints, mobile stations, laptop-embedded equipment (LEE), laptop-mounted equipment (LME), USB dongles, smart devices, wireless customer-premises equipment (CPE) and the like. In the following description, the terms “terminal device”, “terminal”, “user equipment” and “UE” may be used interchangeably. As one example, a UE may represent an entity configured for communication in accordance with one or more communication standards promulgated by the 3rd Generation Partnership Project (3GPP), such as 3GPP′s GSM, UMTS, LTE, and/or 5G standards. As used herein, a “user equipment” or “UE” may not necessarily have a “user” in the sense of a human user who owns and/or operates the relevant device.

In some embodiments, a UE may be configured to transmit and/or receive information without direct human interaction. For instance, a UE may be designed to transmit information to a network on a predetermined schedule, when triggered by an internal or external event, or in response to requests from the wireless communication network. Instead, a UE may represent a device that is intended for sale to, or operation by, a human user but that may not initially be associated with a specific human user.

As yet another example, in an Internet of Things (I0T) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a MTC device. As one particular example, the terminal device may be a UE implementing the 3GPP NB-IoT standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

As used herein, a downlink, DL transmission refers to a transmission from the network node to a UE, and an uplink, UL transmission refers to a transmission in an opposite direction.

As used herein, the term “and/or” includes any and all combinations of one or more of the associated listed terms.

In the following description and claims, unless defined otherwise, all technical and scientific terms used herein have the same meaning as commonly understood by one of ordinary skills in the art to which this disclosure belongs.

The grant allocated in dynamic scheduling is referred to as a dynamic grant, and the grant allocated in configured scheduling is referred to as a configured grant throughout the specification. Both the dynamic grant and the configured grant are examples of uplink grants.

In addition, ordinal numbers such as first, second, third, etc. are used hereinafter to distinguish the defined terms, rather than limiting the terms. For example, the first radio node and the second radio node are different nodes, but the second radio node may also perform the functions described in connection with the first radio node.

In 3GPP TS 38.321-V15.3.0 (referred to as Rel-15 below), the grant skipping behavior for a UE is defined as the following:
“The MAC entity shall not generate a MAC PDU for the HARQ entity if the following conditions are satisfied:
the MAC entity is configured with skipUplinkTxDynamic and the grant indicated to the HARQ entity was addressed to a C-RNTI, or the grant indicated to the HARQ entity is a configured uplink grant; and
there is no aperiodic CSI requested for this PUSCH transmission as specified in TS 38.212; and
the MAC PDU includes zero MAC SDUs; and
the MAC PDU includes only the periodic BSR and there is no data available for any LCG, or the MAC PDU includes only the padding BSR.”

According to the definition, a UE can determine if a dynamic uplink grant or configured uplink grant can be skipped when at least one above condition is fulfilled. When grant skipping occurs, the grant is dropped without any transmission with the grant.

However, such rule may not always be feasible in different scenarios. For example, in an IAB network, when configured uplink scheduling is activated in an upstream backhaul hop, a configured uplink grant may be skipped on certain time positions in case the UL buffer is empty. That would lead to the resource wastage. Similar issue may occur for a dynamic grant.

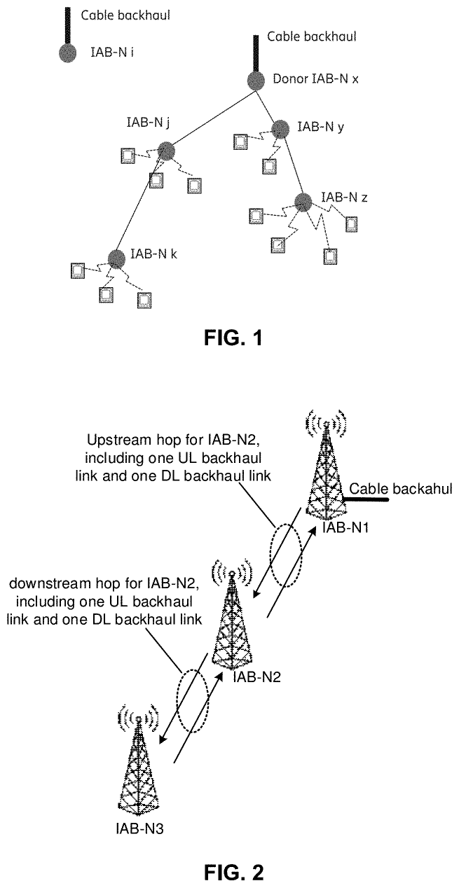

FIG. 1 illustrates one example of an IAB system 100 in which embodiments of the present disclosure may be implemented.

For an NR system with integrated access backhaul (IAB) capable, an access point can setup a radio connection to another access point in order to reach a donor access point which has wireline backhaul, wherein an access point is also referred to as IAB node. The radio connection between IAB nodes (IAB-Ns) is referred to as wireless backhaul or self-backhaul. The donor IAB-N (IAB-N x in FIG. 1) has a cable backhaul to the gateway. The IAB-N y acts as a bridge node between the IAB-N x and IAB-N z, where IAB-N y is referred to as a parent IAB-N of IAB z and IAB-N z is referred to as a child IAB-N of IAB-N y. In another branch, the IAB-N k connected to IAB-N j, and IAB-N j connected to IAB-N x. Each IAB-N may also have UEs connected to it. The UEs are shown as squares in FIG. 1.

For an IAB, there can be three type of links:
upstream links to/from the parent IAB-N;
downstream link to/from the child IAB-N;
a number of downlink/uplink access links to the served UEs;

The first two types of links are also referred to as backhaul links.

An IAB system, which comprises a number of IAB-Ns and served UEs, is supposed to handle the resource allocation among these links. There can be different types of resource allocation strategy, for instance:
Distributed resource allocation mechanism: each IAB-node allocates resources among the three types of links by itself with/without coordination between IAB-Ns;
Centralized resource allocation mechanism: a certain control function unit (e.g. a unit located in the donor IAB-N) configures the resource allocation according to the reported information from child IAB-Ns.

FIG. 2 illustrates one example of upstream backhaul links and downstream backhaul links in an IAB network.

For an IAB system as shown in FIG. 2, upstream backhaul links and downstream backhaul links are deployed at the same carrier(s), meaning that upstream (UL/DL) backhaul links and downstream (UL/DL) backhaul links may share the same medium. The occurrence of empty buffer in an uplink of an upstream hop (comprising a DL backhaul link and a UL backhaul link) may not be together with the occurrence of empty DL/UL buffers of a downstream hop (comprising a DL backhaul link and a UL backhaul link). Simply skipping a UL grant according to Rel-15 procedure is not efficient considering that an IAB node may need resources for data transmission in a downstream hop while the radio resources of the skipped UL grant of an upstream hop are wasted.

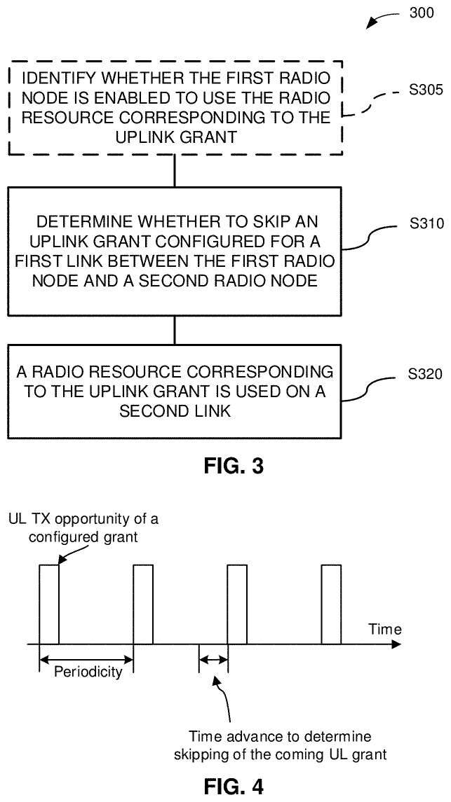

Hereinafter, a method for optimizing the uplink grant skipping behavior of a radio node according to an exemplary embodiment of the present disclosure will be described with reference to FIGS. 3 to 5.

FIG. 3 illustratively shows a flowchart of a method 300 for enhanced grant skipping according to an exemplary embodiment of the present disclosure. In an exemplary embodiment, the method 300 may be performed at a first radio node.

As shown in FIG. 3, the method 300 may include Steps S310-S320.

In Step S310, it is determined whether to skip an uplink grant configured for a first link between the first radio node and a second radio node. In response to determining to skip the uplink grant, the method proceeds to step S320, in which a radio resource corresponding to the uplink grant is used on a second link.

Take the IAB system 100 shown in FIG. 1 as an example, where the IAB-N y is taken as the first radio node, and the IAB-B x is taken as the second radio node.

When IAB-N y is provided with an uplink grant for the link between IAB-N y and IAB-N x but it has no data to transmit to IAB-N x, IAB-N y determines to skip the uplink grant. The uplink grant is configured for the link between IAB-N y and IAB-N x, referred to as a first link in the embodiment.

In order to improve the resource efficiency, in an exemplary embodiment of the present disclosure, the radio resource corresponding to the uplink grant is used on a different link, referred to as a second link, which is different from the first link.

According to an embodiment, prior to using a resource corresponding to the uplink grant, the method 300 may further include Step S305 in which it identifies whether the first radio node is enabled to use the radio resource corresponding to the uplink grant.

The network (e.g. an IAB node or an Operation Administration and Maintenance (OAM) node) can configure if the enhanced grant skipping according to the present disclosure is allowed for a first radio node. For instance, the network can configure if the enhanced grant skipping according to the present disclosure is allowed for either or both of dynamic uplink grant and configured UL grant. If such enhanced grant skipping is not configured, the first radio node performs the UL grant skipping according to Rel-15 procedure. Accordingly, the first radio node will identify whether it is configured to perform the enhanced grant skipping according to the present disclosure before using the radio resource corresponding to the uplink grant.

According to an embodiment, Step S310 is performed at least a predefined time period ahead of starting of a data transmission using the radio resource corresponding to the uplink grant or during a transmission duration of the uplink grant.

In an exemplary embodiment of the present disclosure, a mechanism is introduced so that the first radio node is able to schedule a radio resource corresponding to a skipped uplink grant. The scheduling is performed either in advance or during the transmission duration of the skipped uplink grant. For instance, it can be configured that the first radio node can determine if a UL grant is to be skipped based on defined conditions (as Rel-15 procedure) at least x slots ahead of the time when the radio resource corresponding to the skipped uplink grant is supposed to start, wherein x can be configured via signaling means such as RRC signaling, or a MAC CE, or a PDCCH signaling. In this case, if an uplink grant is to be kipped, the new data transmission or reception by using the radio resource corresponding to the skipped uplink grant would occur, afterwards. An example is further illustrated in FIG. 4.

FIG. 4 shows the relation between the step of determining whether to skip an uplink grant and the starting of a data transmission using a radio resource corresponding to the uplink grant. The uplink grant is a configured grant shown in FIG. 4. The configured grant is configured to occur in a periodicity. The first radio node which is configured with the periodic configured grant will determine whether to skip a next uplink grant based on define conditions (as Rel-15 procedure) at a time, and if it is determined to skip, the first radio node will schedule the radio resource corresponding to the skipped uplink grant and use the radio resource to perform a data transmission. The time gap between the determination of skipping an uplink grant and the starting of the data transmission using a radio resource of the uplink grant is configured so that the first radio node has sufficient time to perform scheduling of the radio resource.

There may be various ways of using a radio resource corresponding to a skipped uplink grant on a second link.

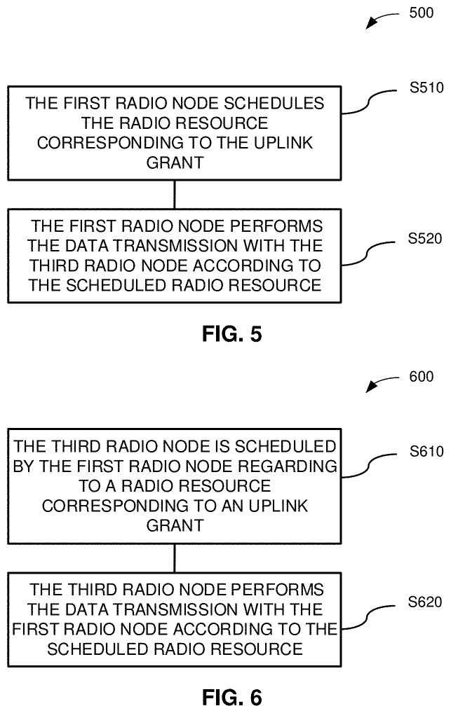

FIG. 5 illustratively shows a flowchart of a method 500 of using a radio resource corresponding to an uplink grant on a second link according to an exemplary embodiment of the present disclosure. FIG. 5 shows an example of Step S320.

As shown in FIG. 5, the method 500 may include Steps S510-S520.

In Step S510, the first radio node schedules the radio resource corresponding to the uplink grant for a data transmission between the first radio node and a third radio node connected to the first radio node. Then the method 500 proceeds to Step S520, in which the first radio node performs the data transmission with the third radio node according to the scheduled radio resource.

Take the IAB system 100 shown in FIG. 1 as an example, where IAB-N z is taken as the third radio node. In the example, the link between IAB-N y and IAB-N z is taken as the second link. If IAB-N y determines to skip an uplink grant which is configured for the first link between IAB-N y and IAB-N x, it is configured to use the radio resource corresponding to the uplink grant on the link between IAB-N y and IAB-N z. If there is a demand for data transmission on the second link, IAB-N y schedules IAB-N z for the data transmission to use the radio resource, and performs the data transmission with IAB-N z according to the scheduled radio resource.

According to an embodiment, a maximum transmission power of the data transmission from the first radio node to the third radio node is either selected to not exceed the allowed maximum uplink transmission power of the first radio node, or preconfigured.

When the first radio node is to use the radio resource of the skipped uplink grant to perform a data transmission with the third radio node, either of the following two options can be adopted to control the maximum transmission power for interference control purpose:
Option 1: the maximum transmission power of the first radio node should not exceed the allowed maximum uplink transmission power of the first radio node to the second radio node;
Option 2: a separate maximum transmission power can be preconfigured by a resource coordination manager (e.g., located in donor IAB node or an OAM node, or any other IAB node in the network).

According to an embodiment, for an uplink dynamic grant or a configured grant available at an IAB node, the existing grant skipping (i.e., in Rel-15) is enhanced, i.e., if the node shall perform grant skipping operation i.e., its MAC entity shall not generate a MAC PDU for the HARQ entity if the following conditions are satisfied:
the MAC entity is configured with skipUplinkTxDynamic and the grant indicated to the HARQ entity was addressed to a C-RNTI, or the grant indicated to the HARQ entity is a configured uplink grant; and
there is no aperiodic CSI requested for this PUSCH transmission as specified in TS 38.212; and
the MAC PDU includes zero MAC SDUs; and
there is no demand for downstream data transmission/reception to/from an IAB node/UE; and
the MAC PDU includes only the periodic BSR and there is no data available for any LCG, or the MAC PDU includes only the padding BSR.”

In other words, the IAB node may have two options to take care of the uplink grant in case there is no uplink/upstream MAC SDUs at this MAC entity to use this grant:

Option 1: the conditions on grant skipping are satisfied, meanwhile, there is a demand for downstream data transmission/reception. In this case, this IAB node can use the radio resource of the uplink grant for a data transmission with a child IAB node or a UE.

Option 2: the conditions on grant skipping are satisfied, however, there is no demand for downstream data transmission. In this case, the uplink grant is skipped. That is, the radio resource corresponding to the uplink grant will not be used.

According to an embodiment, Step S320 may further include a step of transmitting an indication to a third radio node connected to the first radio node to indicate the radio resource corresponding to the uplink grant is available to the third radio node.

As an example, for the Option 2 mentioned above in which the conditions on grant skipping are satisfied but there is no demand for downstream data transmission, the IAB node has no demand for downstream data transmission, and it may transmit an indication to its downstream node, indicating the radio resource corresponding to the uplink grant is available to the downstream node. The downstream node then can use the radio resource for a data transmission with its downstream node. In the embodiment, the radio resource corresponding to the uplink grant is not used by the IAB node, but used by the downstream node of the IAB node. The resource efficiency of the system is also improved.

According to an embodiment, the radio resource corresponding to the uplink grant comprises at least one of: time resource, frequency resource, power resource and antenna resource. For example, the first radio node may use its antenna resource of a skipped uplink grant to perform a data transmission on its downstream with the third radio node.

According to another embodiment, the uplink grant is a configured uplink grant or a dynamically scheduled uplink grant.

According to still another embodiment, the first radio node is one of an Integrated Access Backhaul (IAB) node in an IAB network, a relay node, a base station (BS) and a device having a Device to Device (D2D) communication with another device. As an example, the first radio node may be IAB-N y as shown in FIG. 1. As another example, the first radio node may be a relay node or a base station that may use a radio resource of a skipped uplink grant configured for a first link on a different second link between itself and a UE or a relay node/base station connected to the first radio node. As still another example, the first radio node may be a D2D device that may use a radio resource of a skipped uplink grant configured for a first link between itself and a second D2D device on a second link between itself and a third D2D device.

FIG. 6 illustratively shows a flowchart of a method 600 for enhanced grant skipping according to an exemplary embodiment of the present disclosure. In an exemplary embodiment, the method 600 may be performed at a third radio node.

As shown in FIG. 6, the method 600 may include Steps S610-S620.

In Step S610, for a data transmission between a first radio node connected to the third radio node and the third radio node, the third radio node is scheduled by the first radio node regarding to a radio resource corresponding to an uplink grant which is configured for a first link between the first radio node and a second radio node and skipped by the first radio node. The method then proceeds to Step S620, in which the third radio node performs the data transmission with the first radio node according to the scheduled radio resource.

Take the IAB system 100 shown in FIG. 1 as an example, where the IAB-N y is taken as the first radio node, the IAB-B x is taken as the second radio node, IAB-N z is taken as the third radio node, and a UE connected to the IAB-N z is taken as the fourth radio node.

When IAB-N y is provided with an uplink grant for the link between IAB-N y and IAB-N x but it has no data to transmit to IAB-N x, IAB-N y determines to skip the uplink grant. The uplink grant is configured for the link between IAB-N y and IAB-N x, referred to as a first link in the embodiment. If there is a demand for data transmission on a second link between IAB-N y and IAB-N z, IAB-N z is scheduled by IAB-N y regarding to the radio resource of the skilled uplink grant, and then performs the data transmission with IAB-N y according to the scheduled radio resource.

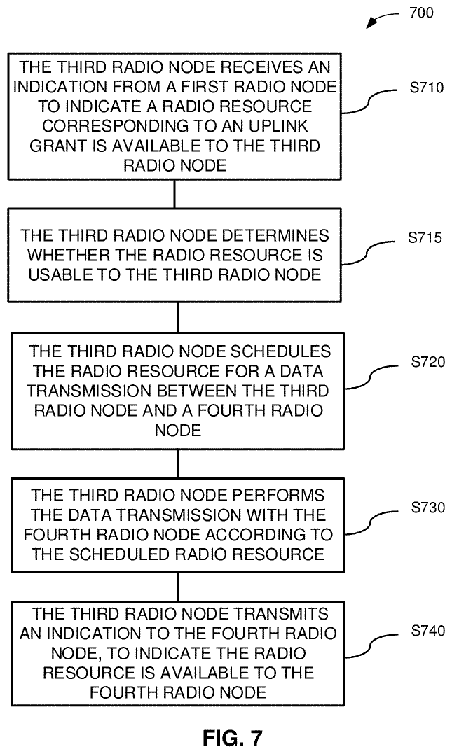

FIG. 7 illustratively shows a flowchart of a method 700 according to an exemplary embodiment of the present disclosure. In an exemplary embodiment, the method 700 may be performed at a third radio node.

As shown in FIG. 7, the method 700 may include Steps S710-S720.

In Step S710, the third radio node receives an indication from a first radio node connected to the third radio node to indicate a radio resource corresponding to an uplink grant is available to the third radio node. The uplink grant is configured for a first link between the first radio node and a second radio node, and the uplink grant is skipped by the first radio node. Then the method 700 proceeds to Step S720, in which the third radio node schedules the radio resource for a data transmission between the third radio node and a fourth radio node connected to the third radio node.

In an exemplary embodiment of the present disclosure, the method 700 further includes Step S730, in which the third radio node performs the data transmission with the fourth radio node according to the scheduled radio resource.

In another embodiment, before Step S720 of scheduling the radio resource, the method 700 further includes Step S715 of determining whether the radio resource is usable to the third radio node. For example, the radio resource corresponding to the uplink grant is over f1 band but the third radio node is operable over f2 band which is different from f1 band. In such case, the radio resource is not usable to the third radio node.

In another embodiment, the method 700 further includes Step S740, in which the third radio node transmits an indication to the fourth radio node, to indicate the radio resource is available to the fourth radio node. For example, if the radio resource is not usable to third radio node, the third radio node may transmit an indication to the fourth radio node, to inform the fourth radio node of availability of the radio node. The fourth radio node may then use the radio resource over a link different from the link between the fourth radio node and the third radio node.

According to an embodiment, a maximum transmission power of the data transmission from the third radio node to the fourth radio node is either selected to not exceed the allowed maximum uplink transmission power of the third radio node to the first radio node, or preconfigured.

When the third radio node is to use the radio resource of the skipped uplink grant to perform a data transmission with the fourth radio node, either of the following two options can be adopted to control the maximum transmission power for interference control purpose:
Option 1: the maximum transmission power of the third radio node should not exceed the allowed maximum uplink transmission power of the third radio node to the fourth radio node;
Option 2: a separate maximum transmission power can be preconfigured by a resource coordination manager (e.g., located in donor IAB node or an OAM node, or any other IAB node in the network).

According to an embodiment, the radio resource corresponding to the uplink grant comprises at least one of: time resource, frequency resource, power resource and antenna resource. For example, the first radio node may use its antenna resource of a skipped uplink grant to perform a data transmission on its downstream with the third radio node.

Take the IAB system 100 shown in FIG. 1 as an example, where the IAB-N y is taken as the first radio node, the IAB-B x is taken as the second radio node, IAB-N z is taken as the third radio node, and a UE connected to the IAB-N z is taken as the fourth radio node.

When IAB-N y is provided with an uplink grant for the link between IAB-N y and IAB-N x but it has no data to transmit to IAB-N x, IAB-N y determines to skip the uplink grant. The uplink grant is configured for the link between IAB-N y and IAB-N x, referred to as a first link in the embodiment. If there is no demand for data transmission on a second link between IAB-N y and IAB-N z, IAB-N y transmits an indication to IAB-N z to indicate the radio resource corresponding to the uplink grant is available to IAB-N z. Upon receiving the indication, IAB-N z schedules the radio resource for a data transmission between IAB-N z and the UE connected to IAB-N z, and may then perform the data transmission with the UE according to the scheduled radio resource. In an example, before scheduling the radio resource, IAB-N z determines whether the radio resource is usable. If the radio resource is not usable to IAB-N z, IAB-N z may transmit transmitting an indication to the UE, to indicate the radio resource is available to the UE.

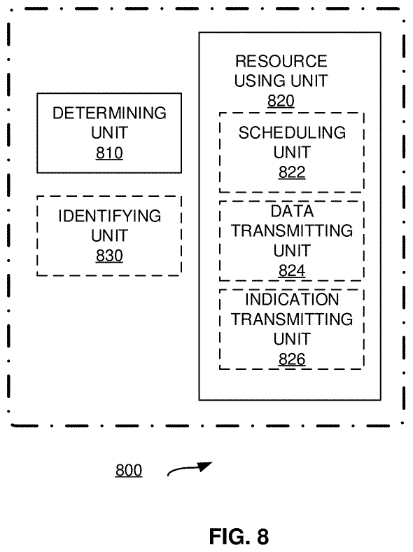

Hereinafter, a structure of a first radio node will be described with reference to FIG. 8. FIG. 8 illustratively shows a schematic structure diagram of an apparatus 800 implemented in a first radio node according to an exemplary embodiment of the present disclosure. The apparatus 800 in FIG. 8 may perform the methods 300 and 500 for enhanced grant skipping described previously with reference to FIGS. 3 and 5. Accordingly, some detailed description on the apparatus 800 may refer to the corresponding description of the methods 300 and 500 for enhanced grant skipping as previously discussed.

As shown in FIG. 8, the apparatus 800 may include a determining unit 810 and a resource using unit 820. As will be understood by the skilled in the art, common components in the apparatus 800 are omitted in FIG. 8 for not obscuring the idea of the present disclosure. Also, some modules may be distributed in more modules or integrated into fewer modules. For example, the determining module 810 and the resource using unit 820 may be integrated into a processor module.

In an exemplary embodiment of the present disclosure, the determining unit 810 of the apparatus 800 may be configured to determine whether to skip an uplink grant configured for a first link between the first radio node and a second radio node. The resource using unit 820 of the apparatus 800 may be configured to, in response to determining to skip the uplink grant, use a radio resource corresponding to the uplink grant on a second link.

Take the IAB system 100 shown in FIG. 1 as an example, where the IAB-N y is taken as the first radio node, and the IAB-B x is taken as the second radio node.

When IAB-N y is provided with an uplink grant for the link between IAB-N y and IAB-N x but it has no data to transmit to IAB-N x, the determining unit 810 in IAB-N y determines to skip the uplink grant. The uplink grant is configured for the link between IAB-N y and IAB-N x, referred to as a first link in the embodiment.

In order to improve the resource efficiency, in an embodiment of the present disclosure, the radio resource corresponding to the uplink grant is used on a different link, referred to as a second link, which is different from the first link.

According to an embodiment, the apparatus 800 may further include an identifying unit 830 which is configured to identify whether the first radio node is enabled to use the radio resource corresponding to the uplink grant.

The network (e.g. an IAB node or an OAM node) can configure if the enhanced grant skipping according to the present disclosure is allowed for a first radio node.

For instance, the network can configure if the enhanced grant skipping according to the present disclosure is allowed for either or both of dynamic uplink grant and configured UL grant. If such enhanced grant skipping is not configured, the first radio node performs the UL grant skipping according to Rel-15 procedure. Accordingly, the identifying unit 830 of the apparatus 800 will identify whether the first radio node is configured to perform the enhanced grant skipping according to the present disclosure before the resource using unit 820 uses the radio resource corresponding to the uplink grant.

According to an embodiment, the determining unit 810 determines whether to skip the uplink grant at least a predefined time period ahead of starting of a data transmission using the radio resource corresponding to the uplink grant or during a transmission duration of the uplink grant.

According to an embodiment, the resource using unit 820 may include a scheduling unit 822 which is configured to schedule the radio resource corresponding to the uplink grant for a data transmission between the first radio node and a third radio node connected to the first radio node, and a data transmitting unit 824 which is configured to perform the data transmission with the third radio node according to the scheduled radio resource.

Take the IAB system 100 shown in FIG. 1 as an example, where the IAB-N y is taken as the first radio node, the IAB-B x is taken as the second radio node, and IAB-N z is taken as the third radio node. In the example, the link between IAB-N y and IAB-N z is taken as the second link. If the determining unit 810 of IAB-N y determines to skip an uplink grant which is configured for the first link between IAB-N y and IAB-N x, the resource using unit 820 of IAB-N y is configured to use the radio resource corresponding to the uplink grant on the link between IAB-N y and IAB-N z. If there is a demand for data transmission on the second link, the scheduling unit 822 of IAB-N y schedules IAB-N z for the data transmission to use the radio resource, and the data transmitting unit 824 performs the data transmission with IAB-N z according to the scheduled radio resource.

According to an embodiment, a maximum transmission power of the data transmission from the first radio node to the third radio node is either selected to not exceed the allowed maximum uplink transmission power of the first radio node, or preconfigured.

According to an embodiment, the resource using unit 820 may include an indication transmitting unit 826 which is configured to transmit an indication to a third radio node connected to the first radio node to indicate the radio resource corresponding to the uplink grant is available to the third radio node.

According to an embodiment, for an uplink dynamic grant or a configured grant available at an IAB node, the existing grant skipping (i.e., in Rel-15) is enhanced, i.e., if the node shall perform grant skipping operation i.e., its MAC entity shall not generate a MAC PDU for the HARQ entity if the following conditions are satisfied:
the MAC entity is configured with skipUplinkTxDynamic and the grant indicated to the HARQ entity was addressed to a C-RNTI, or the grant indicated to the HARQ entity is a configured uplink grant; and
there is no aperiodic CSI requested for this PUSCH transmission as specified in TS 38.212; and
the MAC PDU includes zero MAC SDUs; and
there is no demand for downstream data transmission/reception to/from an IAB node/UE; and
the MAC PDU includes only the periodic BSR and there is no data available for any LCG, or the MAC PDU includes only the padding BSR.”

As an example, for the Option 2 mentioned above in which the conditions on grant skipping are satisfied but there is no demand for downstream data transmission, the IAB node has no demand for downstream data transmission, and it may transmit an indication to its downstream node, indicating the radio resource corresponding to the uplink grant is available to the downstream node. The downstream node then can use the radio resource for a data transmission with its downstream node. In the embodiment, the radio resource corresponding to the uplink grant is not used by the IAB node, but used by the downstream node of the IAB node. The resource efficiency of the system is also improved.

According to an embodiment, the radio resource corresponding to the uplink grant comprises at least one of: time resource, frequency resource, power resource and antenna resource. For example, the first radio node may use its antenna resource of a skipped uplink grant to perform a data transmission on its downstream with the third radio node.

According to another embodiment, the uplink grant is a configured uplink grant or a dynamically scheduled uplink grant.

According to still another embodiment, the first radio node is one of an Integrated Access Backhaul (IAB) node in an IAB network, a relay node, a base station (BS) and a device having a Device to Device (D2D) communication with another device. As an example, the first radio node may be IAB-N y as shown in FIG. 1. As another example, the first radio node may be a relay node or a base station that may use a radio resource of a skipped uplink grant configured for a first link on a different second link between itself and a UE or a relay node/base station connected to the first radio node. As still another example, the first radio node may be a D2D device that may use a radio resource of a skipped uplink grant configured for a first link between itself and a second D2D device on a second link between itself and a third D2D device.

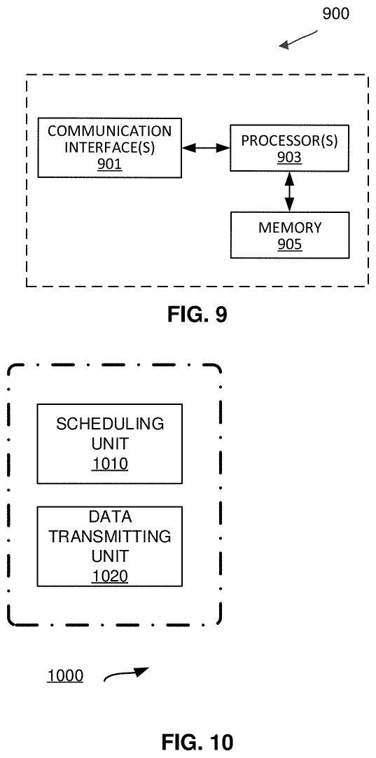

Hereinafter, another structure of a first radio node will be described with reference to FIG. 9. FIG. 9 illustratively shows a schematic structure diagram of an apparatus 900 implemented in a first radio node according to an exemplary embodiment of the present disclosure. The apparatus 800 in FIG. 8 may perform the methods 300 and 500 for enhanced grant skipping described previously with reference to FIGS. 3 and 5. Accordingly, some detailed description on the apparatus 800 may refer to the corresponding description of the methods 300 and 500 for enhanced grant skipping as previously discussed.

As shown in FIG. 9, the apparatus 900 may include at least one controller or processor 903 including e.g., any suitable Central Processing Unit, CPU, microcontroller, Digital Signal Processor, DSP, etc., capable of executing computer program instructions. The computer program instructions may be stored in a memory 905. The memory 905 may be any combination of a Random Access Memory (RAM) and a Read Only Memory (ROM). The memory may also comprise persistent storage, which, for example, can be any single one or combination of magnetic memory, optical memory, or solid state memory or even remotely mounted memory. The exemplary apparatus 900 further comprises a communication interface 901 arranged for communication.

The instructions, when loaded from the memory 905 and executed by the at least one processor 903, may cause the apparatus 900 implemented in the first radio node to perform the methods 300 and 500 for enhanced grant skipping described previously with reference to FIGS. 3 and 5.

In particular, in an exemplary embodiment of the present disclosure, the instructions, when loaded from the memory 905 and executed by the at least one processor 903, may cause the first radio node to determine whether to skip an uplink grant configured for a first link between the first radio node and a second radio node

In response to determining to skip the uplink grant, the instructions, when loaded from the memory 905 and executed by the at least one processor 903, may cause the first radio node to use a radio resource corresponding to the uplink grant on a second link.

Take the IAB system 100 shown in FIG. 1 as an example, where the IAB-N y is taken as the first radio node, and the IAB-B x is taken as the second radio node.

When IAB-N y is provided with an uplink grant for the link between IAB-N y and IAB-N x but it has no data to transmit to IAB-N x, the instructions, when loaded from the memory 905 and executed by the at least one processor 903, may cause IAB-N y to determine whether to skip the uplink grant, and in response to determining to skip the uplink grant, use a radio resource corresponding to the uplink grant on a second link. The uplink grant is configured for the link between IAB-N y and IAB-N x, referred to as a first link in the embodiment.

In order to improve the resource efficiency, in an exemplary embodiment of the present disclosure, the radio resource corresponding to the uplink grant is used on a different link, referred to as a second link, which is different from the first link.

In an exemplary embodiment of the present disclosure, the instructions, when loaded from the memory 905 and executed by the at least one processor 903, may cause the first radio node to identify whether the first radio node is enabled to use the radio resource corresponding to the uplink grant.

The network (e.g. an IAB node or an OAM node) can configure if the enhanced grant skipping according to the present disclosure is allowed for a first radio node. For instance, the network can configure if the enhanced grant skipping according to the present disclosure is allowed for either or both of dynamic uplink grant and configured UL grant. If such enhanced grant skipping is not configured, the first radio node performs the UL grant skipping according to Rel-15 procedure. Accordingly, the instructions, when loaded from the memory 905 and executed by the at least one processor 903, may cause the first radio node to identify whether the first radio node is configured to perform the enhanced grant skipping according to the present disclosure before using the radio resource corresponding to the uplink grant.

According to an embodiment, the apparatus 900 determines whether to skip the uplink grant at least a predefined time period ahead of starting of a data transmission using the radio resource corresponding to the uplink grant or during a transmission duration of the uplink grant.

According to an embodiment, the instructions, when loaded from the memory 905 and executed by the at least one processor 903, may cause the first radio node to schedule the radio resource corresponding to the uplink grant for a data transmission between the first radio node and a third radio node connected to the first radio node.

According to another embodiment, the instructions, when loaded from the memory 905 and executed by the at least one processor 903, may cause the first radio node to perform the data transmission with the third radio node according to the scheduled radio resource.

Take the IAB system 100 shown in FIG. 1 as an example, where the IAB-N y is taken as the first radio node, the IAB-B x is taken as the second radio node, and IAB-N z is taken as the third radio node. In the example, the link between IAB-N y and IAB-N z is taken as the second link. If the apparatus 900 of IAB-N y determines to skip an uplink grant which is configured for the first link between IAB-N y and IAB-N x, the apparatus 900 of IAB-N y is configured to use the radio resource corresponding to the uplink grant on the link between IAB-N y and IAB-N z. If there is a demand for data transmission on the second link, the apparatus 900 of IAB-N y schedules IAB-N z for the data transmission to use the radio resource, and performs the data transmission with IAB-N z according to the scheduled radio resource.

According to an embodiment, a maximum transmission power of the data transmission from the first radio node to the third radio node is either selected to not exceed the allowed maximum uplink transmission power of the first radio node, or preconfigured.

According to another embodiment, the instructions, when loaded from the memory 905 and executed by the at least one processor 903, may cause the first radio node to transmit an indication to a third radio node connected to the first radio node to indicate the radio resource corresponding to the uplink grant is available to the third radio node.

According to an embodiment, for an uplink dynamic grant or a configured grant available at an IAB node, the existing grant skipping (i.e., in Rel-15) is enhanced, i.e., if the node shall perform grant skipping operation i.e., its MAC entity shall not generate a MAC PDU for the HARQ entity if the following conditions are satisfied:
the MAC entity is configured with skipUplinkTxDynamic and the grant indicated to the HARQ entity was addressed to a C-RNTI, or the grant indicated to the HARQ entity is a configured uplink grant; and
there is no aperiodic CSI requested for this PUSCH transmission as specified in TS 38.212; and
the MAC PDU includes zero MAC SDUs; and
there is no demand for downstream data transmission/reception to/from an IAB node/UE; and
the MAC PDU includes only the periodic BSR and there is no data available for any LCG, or the MAC PDU includes only the padding BSR.”

As an example, for the Option 2 mentioned above in which the conditions on grant skipping are satisfied but there is no demand for downstream data transmission, the IAB node has no demand for downstream data transmission, and it may transmit an indication to its downstream node, indicating the radio resource corresponding to the uplink grant is available to the downstream node. The downstream node then can use the radio resource for a data transmission with its downstream node. In the embodiment, the radio resource corresponding to the uplink grant is not used by the IAB node, but used by the downstream node of the IAB node. The resource efficiency of the system is also improved.

According to an embodiment, the radio resource corresponding to the uplink grant comprises at least one of: time resource, frequency resource, power resource and antenna resource. For example, the first radio node may use its antenna resource of a skipped uplink grant to perform a data transmission on its downstream with the third radio node.

According to another embodiment, the uplink grant is a configured uplink grant or a dynamically scheduled uplink grant.

According to still another embodiment, the first radio node is one of an Integrated Access Backhaul (IAB) node in an IAB network, a relay node, a base station (BS) and a device having a Device to Device (D2D) communication with another device. As an example, the first radio node may be IAB-N y as shown in FIG. 1. As another example, the first radio node may be a relay node or a base station that may use a radio resource of a skipped uplink grant configured for a first link on a different second link between itself and a UE or a relay node/base station connected to the first radio node. As still another example, the first radio node may be a D2D device that may use a radio resource of a skipped uplink grant configured for a first link between itself and a second D2D device on a second link between itself and a third D2D device.

Hereinafter, a structure of a third radio node will be described with reference to FIG. 10. FIG. 10 illustratively shows a schematic structure diagram of an apparatus 1000 implemented in a third radio node according to an exemplary embodiment of the present disclosure. The apparatus 1000 in FIG. 10 may perform the method 600 for enhanced grant skipping described previously with reference to FIG. 6. Accordingly, some detailed description on the apparatus 1000 may refer to the corresponding description of the method 600 for enhanced grant skipping as previously discussed.

As shown in FIG. 10, the apparatus 1000 may include a scheduling unit 1010 and a data transmitting unit 1020. As will be understood by the skilled in the art, common components in the apparatus 1000 are omitted in FIG. 10 for not obscuring the idea of the present disclosure. Also, some modules may be distributed in more modules or integrated into fewer modules. For example, part of the scheduling unit 1010 and the data transmitting unit 1020 may be integrated into a transceiver module.

In an exemplary embodiment of the present disclosure, the scheduling unit 1010 is configured to be scheduled by the first radio node regarding to a radio resource corresponding to an uplink grant which is configured for a first link between the first radio node and a second radio node and skipped by the first radio node, and the data transmitting unit 1020 is configured to perform the data transmission with the first radio node according to the scheduled radio resource.

Take the IAB system 100 shown in FIG. 1 as an example, where the IAB-N y is taken as the first radio node, the IAB-B x is taken as the second radio node, IAB-N z is taken as the third radio node, and a UE connected to the IAB-N z is taken as the fourth radio node.

When IAB-N y is provided with an uplink grant for the link between IAB-N y and IAB-N x but it has no data to transmit to IAB-N x, IAB-N y determines to skip the uplink grant. The uplink grant is configured for the link between IAB-N y and IAB-N x, referred to as a first link in the embodiment. If there is a demand for data transmission on a second link between IAB-N y and IAB-N z, the scheduling unit 1010 of IAB-N z is scheduled by IAB-N y regarding to the radio resource of the skilled uplink grant, and then the data transmitting unit 1020 of IAB-N z performs the data transmission with IAB-N y according to the scheduled radio resource.

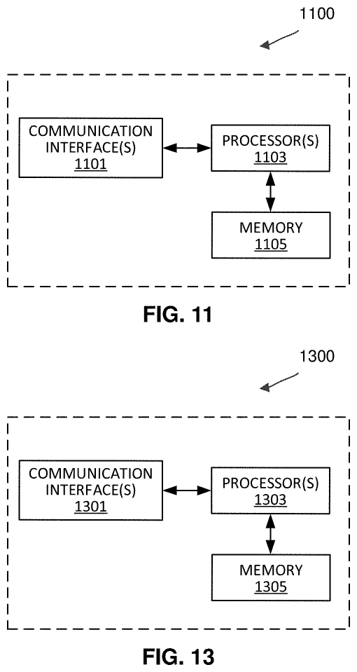

Hereinafter, another structure of a third radio node will be described with reference to FIG. 11. FIG. 11 illustratively shows a schematic structure diagram of an apparatus 1100 implemented in a third radio node according to an exemplary embodiment of the present disclosure. The apparatus 1100 in FIG. 11 may perform the method 600 for enhanced grant skipping described previously with reference to FIG. 6. Accordingly, some detailed description on the apparatus 1000 may refer to the corresponding description of the method 600 for enhanced grant skipping as previously discussed.

As shown in FIG. 11, the apparatus 1100 may include at least one controller or processor 1103 including e.g., any suitable Central Processing Unit, CPU, microcontroller, Digital Signal Processor, DSP, etc., capable of executing computer program instructions. The computer program instructions may be stored in a memory 1105. The memory 1105 may be any combination of a Random Access Memory (RAM) and a Read Only Memory (ROM). The memory may also comprise persistent storage, which, for example, can be any single one or combination of magnetic memory, optical memory, or solid state memory or even remotely mounted memory. The exemplary apparatus 1100 further comprises a communication interface 1101 arranged for communication.

The instructions, when loaded from the memory 1105 and executed by the at least one processor 1103, may cause the apparatus 1100 implemented in the third radio node to perform the method 600 for enhanced grant skipping described previously with reference to FIG. 6.

In particular, in an exemplary embodiment of the present disclosure, the instructions, when loaded from the memory 1105 and executed by the at least one processor 1103, may cause the third radio node to be, for a data transmission between a first radio node connected to the third radio node and the third radio node, scheduled by the first radio node regarding to a radio resource corresponding to an uplink grant which is configured for a first link between the first radio node and a second radio node and skipped by the first radio node; and perform the data transmission with the first radio node according to the scheduled radio resource.

Take the IAB system 100 shown in FIG. 1 as an example, where the IAB-N y is taken as the first radio node, the IAB-B x is taken as the second radio node, IAB-N z is taken as the third radio node, and a UE connected to the IAB-N z is taken as the fourth radio node.

When IAB-N y is provided with an uplink grant for the link between IAB-N y and IAB-N x but it has no data to transmit to IAB-N x, IAB-N y determines to skip the uplink grant. The uplink grant is configured for the link between IAB-N y and IAB-N x, referred to as a first link in the embodiment. If there is a demand for data transmission on a second link between IAB-N y and IAB-N z, the instructions, when loaded from the memory 1105 and executed by the at least one processor 1103, may cause the apparatus 1100 implemented in IAB-N z to be scheduled by IAB-N y regarding to the radio resource of the skilled uplink grant, and perform the data transmission with IAB-N y according to the scheduled radio resource.

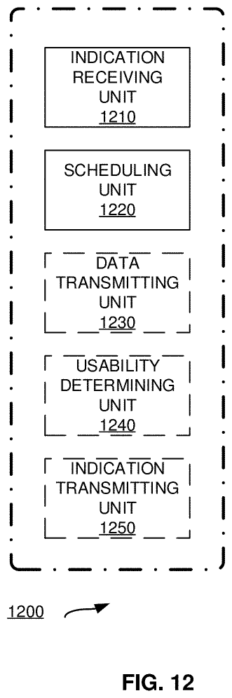

Hereinafter, a structure of a third radio node will be described with reference to FIG. 12. FIG. 12 illustratively shows a schematic structure diagram of an apparatus 1200 implemented in a third radio node according to an exemplary embodiment of the present disclosure. The apparatus 1200 in FIG. 12 may perform the method 700 for enhanced grant skipping described previously with reference to FIG. 7. Accordingly, some detailed description on the apparatus 1200 may refer to the corresponding description of the method 700 for enhanced grant skipping as previously discussed.

As shown in FIG. 12, the apparatus 1200 may include an indication receiving unit 1210 and a scheduling unit 1220. As will be understood by the skilled in the art, common components in the apparatus 1200 are omitted in FIG. 12 for not obscuring the idea of the present disclosure. Also, some modules may be distributed in more modules or integrated into fewer modules. For example, part of the indication receiving unit 1210 and the scheduling unit 1220 may be integrated into a transceiver module.

In an exemplary embodiment of the present disclosure, the indication receiving unit 1210 is configured to receive an indication from a first radio node connected to the third radio node to indicate a radio resource corresponding to an uplink grant is available to the third radio node. The uplink grant is configured for a first link between the first radio node and a second radio node, and the uplink grant is skipped by the first radio node. The scheduling unit 1220 is configured to schedule the radio resource for a data transmission between the third radio node and a fourth radio node connected to the third radio node.

In an exemplary embodiment of the present disclosure, the apparatus 1200 may further include a data transmitting unit 1230 which is configured to perform the data transmission with the fourth radio node according to the scheduled radio resource.

In an exemplary embodiment of the present disclosure, the apparatus 1200 may further include a usability determining unit 1240 which is configured to determine whether the radio resource is usable to the third radio node. For example, the radio resource corresponding to the uplink grant is over f1 band but the third radio node is operable over f2 band which is different from f1 band. In such case, the radio resource is not usable to the third radio node.

In another embodiment of the present disclosure, the apparatus 1200 may further include an indication transmitting unit 1250 which is configured to transmit an indication to the fourth radio node, to indicate the radio resource is available to the fourth radio node. For example, if the radio resource is not usable to third radio node, the third radio node may transmit an indication to the fourth radio node, to inform the fourth radio node of availability of the radio node. The fourth radio node may then use the radio resource over a link different from the link between the fourth radio node and the third radio node.

According to an exemplary embodiment of the present disclosure, a maximum transmission power of the data transmission from the third radio node to the fourth radio node is either selected to not exceed the allowed maximum uplink transmission power of the third radio node to the first radio node, or preconfigured.

When the third radio node is to use the radio resource of the skipped uplink grant to perform a data transmission with the fourth radio node, either of the following two options can be adopted to control the maximum transmission power for interference control purpose:
Option 1: the maximum transmission power of the third radio node should not exceed the allowed maximum uplink transmission power of the third radio node to the fourth radio node;
Option 2: a separate maximum transmission power can be preconfigured by a resource coordination manager (e.g., located in donor IAB node or an OAM node, or any other IAB node in the network).

According to an exemplary embodiment of the present disclosure, the radio resource corresponding to the uplink grant comprises at least one of: time resource, frequency resource, power resource and antenna resource. For example, the first radio node may use its antenna resource of a skipped uplink grant to perform a data transmission on its downstream with the third radio node.

Take the IAB system 100 shown in FIG. 1 as an example, where the IAB-N y is taken as the first radio node, the IAB-B x is taken as the second radio node, IAB-N z is taken as the third radio node, and a UE connected to the IAB-N z is taken as the fourth radio node.

When IAB-N y is provided with an uplink grant for the link between IAB-N y and IAB-N x but it has no data to transmit to IAB-N x, IAB-N y determines to skip the uplink grant. The uplink grant is configured for the link between IAB-N y and IAB-N x, referred to as a first link in the embodiment. If there is no demand for data transmission on a second link between IAB-N y and IAB-N z, IAB-N y transmits an indication to IAB-N z to indicate the radio resource corresponding to the uplink grant is available to IAB-N z. When the indication receiving unit 1210 receives the indication, the scheduling unit 1220 of IAB-N z schedules the radio resource for a data transmission between IAB-N z and the UE connected to IAB-N z, and the data transmitting unit 1230 may then perform the data transmission with the UE according to the scheduled radio resource. In an example, before the scheduling unit 1220 schedules the radio resource, the usability determining unit 1240 of IAB-N z determines whether the radio resource is usable. If the radio resource is not usable to IAB-N z, the indication transmitting unit 1250 of IAB-N z may transmit an indication to the UE, to indicate the radio resource is available to the UE.

Hereinafter, another structure of a third radio node will be described with reference to FIG. 13. FIG. 13 illustratively shows a schematic structure diagram of an apparatus 1300 implemented in a third radio node according to an exemplary embodiment of the present disclosure. The apparatus 1300 in FIG. 13 may perform the method 700 for enhanced grant skipping described previously with reference to FIG. 7. Accordingly, some detailed description on the apparatus 1300 may refer to the corresponding description of the method 700 for enhanced grant skipping as previously discussed.

As shown in FIG. 13, the apparatus 1300 may include at least one controller or processor 1303 including e.g., any suitable Central Processing Unit, CPU, microcontroller, Digital Signal Processor, DSP, etc., capable of executing computer program instructions. The computer program instructions may be stored in a memory 1305. The memory 1305 may be any combination of a Random Access Memory (RAM) and a Read Only Memory (ROM). The memory may also comprise persistent storage, which, for example, can be any single one or combination of magnetic memory, optical memory, or solid state memory or even remotely mounted memory. The exemplary apparatus 1300 further comprises a communication interface 1301 arranged for communication.

The instructions, when loaded from the memory 1305 and executed by the at least one processor 1303, may cause the apparatus 1300 implemented in the third radio node to perform the method 700 for enhanced grant skipping described previously with reference to FIG. 7.

In particular, in an exemplary embodiment of the present disclosure, the instructions, when loaded from the memory 1305 and executed by the at least one processor 1303, may cause the third radio node to receive an indication from a first radio node connected to the third radio node to indicate a radio resource corresponding to an uplink grant is available to the third radio node. The uplink grant is configured for a first link between the first radio node and a second radio node, and the uplink grant is skipped by the first radio node. The instructions, when loaded from the memory 1305 and executed by the at least one processor 1303, may further cause the third radio node to schedule the radio resource for a data transmission between the third radio node and a fourth radio node connected to the third radio node.

In an exemplary embodiment of the present disclosure, the instructions, when loaded from the memory 1305 and executed by the at least one processor 1303, may cause the third radio node to perform the data transmission with the fourth radio node according to the scheduled radio resource.

In an exemplary embodiment of the present disclosure, the instructions, when loaded from the memory 1305 and executed by the at least one processor 1303, may cause the third radio node to determine whether the radio resource is usable to the third radio node. For example, the radio resource corresponding to the uplink grant is over f1 band but the third radio node is operable over f2 band which is different from f1 band. In such case, the radio resource is not usable to the third radio node.

In an exemplary embodiment of the present disclosure, the instructions, when loaded from the memory 1305 and executed by the at least one processor 1303, may cause the third radio node to transmit an indication to the fourth radio node, to indicate the radio resource is available to the fourth radio node. For example, if the radio resource is not usable to third radio node, the third radio node may transmit an indication to the fourth radio node, to inform the fourth radio node of availability of the radio node. The fourth radio node may then use the radio resource over a link different from the link between the fourth radio node and the third radio node.

According to an exemplary embodiment of the present disclosure, a maximum transmission power of the data transmission from the third radio node to the fourth radio node is either selected to not exceed the allowed maximum uplink transmission power of the third radio node to the first radio node, or preconfigured.

When the third radio node is to use the radio resource of the skipped uplink grant to perform a data transmission with the fourth radio node, either of the following two options can be adopted to control the maximum transmission power for interference control purpose:
Option 1: the maximum transmission power of the third radio node should not exceed the allowed maximum uplink transmission power of the third radio node to the fourth radio node;
Option 2: a separate maximum transmission power can be preconfigured by a resource coordination manager (e.g., located in donor IAB node or an OAM node, or any other IAB node in the network).

According to an exemplary embodiment of the present disclosure, the radio resource corresponding to the uplink grant comprises at least one of: time resource, frequency resource, power resource and antenna resource. For example, the first radio node may use its antenna resource of a skipped uplink grant to perform a data transmission on its downstream with the third radio node.

Take the IAB system 100 shown in FIG. 1 as an example, where the IAB-N y is taken as the first radio node, the IAB-B x is taken as the second radio node, IAB-N z is taken as the third radio node, and a UE connected to the IAB-N z is taken as the fourth radio node.

When IAB-N y is provided with an uplink grant for the link between IAB-N y and IAB-N x but it has no data to transmit to IAB-N x, IAB-N y determines to skip the uplink grant. The uplink grant is configured for the link between IAB-N y and IAB-N x, referred to as a first link in the embodiment. If there is no demand for data transmission on a second link between IAB-N y and IAB-N z, IAB-N y transmits an indication to IAB-N z to indicate the radio resource corresponding to the uplink grant is available to IAB-N z. The instructions, when loaded from the memory 1305 and executed by the at least one processor 1303, may cause IAB-N z to receive the indication, and schedule the radio resource for a data transmission between IAB-N z and the UE connected to IAB-N z. In an embodiment, the instructions, when loaded from the memory 1305 and executed by the at least one processor 1303, may cause IAB-N z to perform the data transmission with the UE according to the scheduled radio resource. In an example, before scheduling the radio resource, the instructions, when loaded from the memory 1305 and executed by the at least one processor 1303, may cause IAB-N z to determine whether the radio resource is usable. If the radio resource is not usable to IAB-N z, the the instructions, when loaded from the memory 1305 and executed by the at least one processor 1303, may cause IAB-N z to transmit an indication to the UE, to indicate the radio resource is available to the UE.

The present disclosure also provides at least one computer program product in the form of a non-volatile or volatile memory, e.g., a non-transitory computer readable storage medium, an Electrically Erasable Programmable Read-Only Memory (EEPROM), a flash memory and a hard drive. The computer program product includes a computer program. The computer program includes: code/computer readable instructions which, when executed by a processor in a network device, cause the network device to perform the actions, e.g., of the procedure described earlier in conjunction with FIGS. 3 and 5-7.

The computer program product may be configured as a computer program code structured in computer program modules. The computer program modules could essentially perform the actions of the flow illustrated in FIGS. 3 and 5-7.

The processor may be a single Central processing unit (CPU), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a non-transitory computer readable storage medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories.

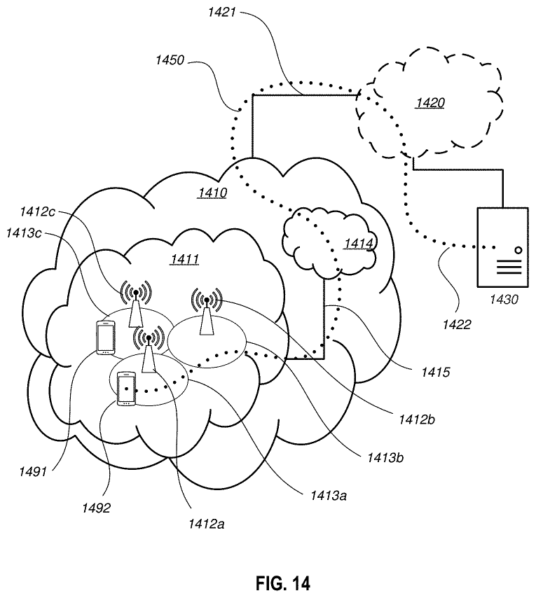

With reference to FIG. 14, in accordance with an embodiment, a communication system includes a telecommunication network 1410, such as a 3GPP-type cellular network, which comprises an access network 1411, such as a radio access network, and a core network 1414. The access network 1411 comprises a plurality of base stations 1412a, 1412b, 1412c, such as NBs, eNBs, gNBs or other types of wireless access points, each defining a corresponding coverage area 1413a, 1413b, 1413c. Each base station 1412a, 1412b, 1412c is connectable to the core network 1414 over a wired or wireless connection 1415. A first user equipment (UE) 1491 located in coverage area 1413c is configured to wirelessly connect to, or be paged by, the corresponding base station 1412c. A second UE 1492 in coverage area 1413a is wirelessly connectable to the corresponding base station 1412a. While a plurality of UEs 1491, 1492 are illustrated in this example, the disclosed embodiments are equally applicable to a situation where a sole UE is in the coverage area or where a sole UE is connecting to the corresponding base station 1412.

The telecommunication network 1410 is itself connected to a host computer 1430, which may be embodied in the hardware and/or software of a standalone server, a cloud-implemented server, a distributed server or as processing resources in a server farm. The host computer 1430 may be under the ownership or control of a service provider, or may be operated by the service provider or on behalf of the service provider. The connections 1421, 1422 between the telecommunication network 1410 and the host computer 1430 may extend directly from the core network 1414 to the host computer 1430 or may go via an optional intermediate network 1420. The intermediate network 1420 may be one of, or a combination of more than one of, a public, private or hosted network; the intermediate network 1420, if any, may be a backbone network or the Internet; in particular, the intermediate network 1420 may comprise two or more sub-networks (not shown).

The communication system of FIG. 14 as a whole enables connectivity between one of the connected UEs 1491, 1492 and the host computer 1430. The connectivity may be described as an over-the-top (OTT) connection 1450. The host computer 1430 and the connected UEs 1491, 1492 are configured to communicate data and/or signaling via the OTT connection 1450, using the access network 1411, the core network 1414, any intermediate network 1420 and possible further infrastructure (not shown) as intermediaries. The OTT connection 1450 may be transparent in the sense that the participating communication devices through which the OTT connection 1450 passes are unaware of routing of uplink and downlink communications. For example, a base station 1412 may not or need not be informed about the past routing of an incoming downlink communication with data originating from a host computer 1430 to be forwarded (e.g., handed over) to a connected UE 1491. Similarly, the base station 1412 need not be aware of the future routing of an outgoing uplink communication originating from the UE 1491 towards the host computer 1430.

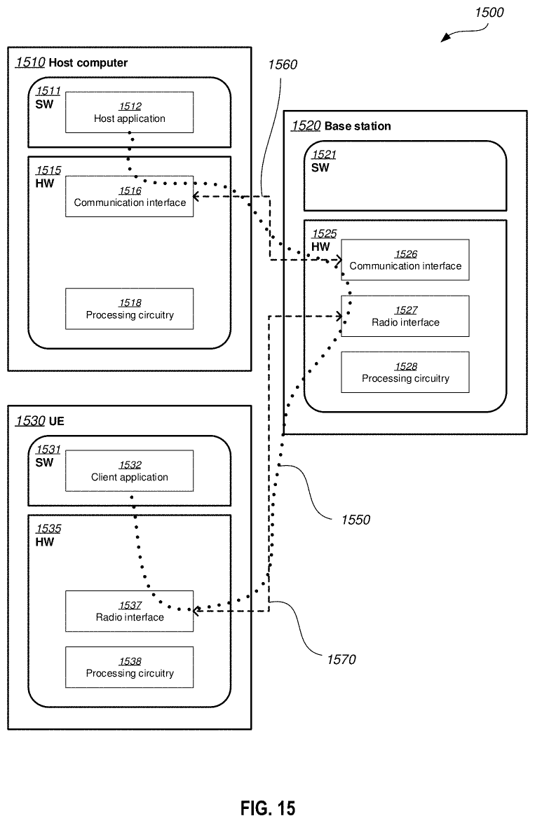

Example implementations, in accordance with an embodiment, of the UE, base station and host computer discussed in the preceding paragraphs will now be described with reference to FIG. 15. In a communication system 1500, a host computer 1510 comprises hardware 1515 including a communication interface 1516 configured to set up and maintain a wired or wireless connection with an interface of a different communication device of the communication system 1500. The host computer 1510 further comprises processing circuitry 1518, which may have storage and/or processing capabilities. In particular, the processing circuitry 1518 may comprise one or more programmable processors, application-specific integrated circuits, field programmable gate arrays or combinations of these (not shown) adapted to execute instructions. The host computer 1510 further comprises software 1511, which is stored in or accessible by the host computer 1510 and executable by the processing circuitry 1518. The software 1511 includes a host application 1512. The host application 1512 may be operable to provide a service to a remote user, such as a UE 1530 connecting via an OTT connection 1550 terminating at the UE 1530 and the host computer 1510. In providing the service to the remote user, the host application 1512 may provide user data which is transmitted using the OTT connection 1550.

The communication system 1500 further includes a base station 1520 provided in a telecommunication system and comprising hardware 1525 enabling it to communicate with the host computer 1510 and with the UE 1530. The hardware 1525 may include a communication interface 1526 for setting up and maintaining a wired or wireless connection with an interface of a different communication device of the communication system 1500, as well as a radio interface 1527 for setting up and maintaining at least a wireless connection 1570 with a UE 1530 located in a coverage area (not shown in FIG. 15) served by the base station 1520. The communication interface 1526 may be configured to facilitate a connection 1560 to the host computer 1510. The connection 1560 may be direct or it may pass through a core network (not shown in FIG. 15) of the telecommunication system and/or through one or more intermediate networks outside the telecommunication system. In the embodiment shown, the hardware 1525 of the base station 1520 further includes processing circuitry 1528, which may comprise one or more programmable processors, application-specific integrated circuits, field programmable gate arrays or combinations of these (not shown) adapted to execute instructions. The base station 1520 further has software 1521 stored internally or accessible via an external connection.

The communication system 1500 further includes the UE 1530 already referred to. Its hardware 1535 may include a radio interface 1537 configured to set up and maintain a wireless connection 1570 with a base station serving a coverage area in which the UE 1530 is currently located. The hardware 1535 of the UE 1530 further includes processing circuitry 1538, which may comprise one or more programmable processors, application-specific integrated circuits, field programmable gate arrays or combinations of these (not shown) adapted to execute instructions. The UE 1530 further comprises software 1531, which is stored in or accessible by the UE 1530 and executable by the processing circuitry 1538. The software 1531 includes a client application 1532. The client application 1532 may be operable to provide a service to a human or non-human user via the UE 1530, with the support of the host computer 1510. In the host computer 1510, an executing host application 1512 may communicate with the executing client application 1532 via the OTT connection 1550 terminating at the UE 1530 and the host computer 1510. In providing the service to the user, the client application 1532 may receive request data from the host application 1512 and provide user data in response to the request data. The OTT connection 1550 may transfer both the request data and the user data. The client application 1532 may interact with the user to generate the user data that it provides.

It is noted that the host computer 1510, base station 1520 and UE 1530 illustrated in FIG. 15 may be identical to the host computer 1430, one of the base stations 1412a, 1412b, 1412c and one of the UEs 1491, 1492 of FIG. 14, respectively. This is to say, the inner workings of these entities may be as shown in FIG. 15 and independently, the surrounding network topology may be that of FIG. 14.

In FIG. 15, the OTT connection 1550 has been drawn abstractly to illustrate the communication between the host computer 1510 and the use equipment 1530 via the base station 1520, without explicit reference to any intermediary devices and the precise routing of messages via these devices. Network infrastructure may determine the routing, which it may be configured to hide from the UE 1530 or from the service provider operating the host computer 1510, or both. While the OTT connection 1550 is active, the network infrastructure may further take decisions by which it dynamically changes the routing (e.g., on the basis of load balancing consideration or reconfiguration of the network).

The wireless connection 1570 between the UE 1530 and the base station 1520 is in accordance with the teachings of the embodiments described throughout this disclosure. One or more of the various embodiments improve the performance of OTT services provided to the UE 1530 using the OTT connection 1550, in which the wireless connection 1570 forms the last segment. More precisely, the teachings of these embodiments may reduce PDCCH detection time and complexity and thereby provide benefits such as reduced user waiting time and reduced power consumption at the UE.

A measurement procedure may be provided for the purpose of monitoring data rate, latency and other factors on which the one or more embodiments improve. There may further be an optional network functionality for reconfiguring the OTT connection 1550 between the host computer 1510 and UE 1530, in response to variations in the measurement results. The measurement procedure and/or the network functionality for reconfiguring the OTT connection 1550 may be implemented in the software 1511 of the host computer 1510 or in the software 1531 of the UE 1530, or both. In embodiments, sensors (not shown) may be deployed in or in association with communication devices through which the OTT connection 1550 passes; the sensors may participate in the measurement procedure by supplying values of the monitored quantities exemplified above, or supplying values of other physical quantities from which software 1511, 1531 may compute or estimate the monitored quantities. The reconfiguring of the OTT connection 1550 may include message format, retransmission settings, preferred routing etc.; the reconfiguring need not affect the base station 1520, and it may be unknown or imperceptible to the base station 1520. Such procedures and functionalities may be known and practiced in the art. In certain embodiments, measurements may involve proprietary UE signaling facilitating the host computer's 1510 measurements of throughput, propagation times, latency and the like. The measurements may be implemented in that the software 1511, 1531 causes messages to be transmitted, in particular empty or ‘dummy’ messages, using the OTT connection 1550 while it monitors propagation times, errors etc.

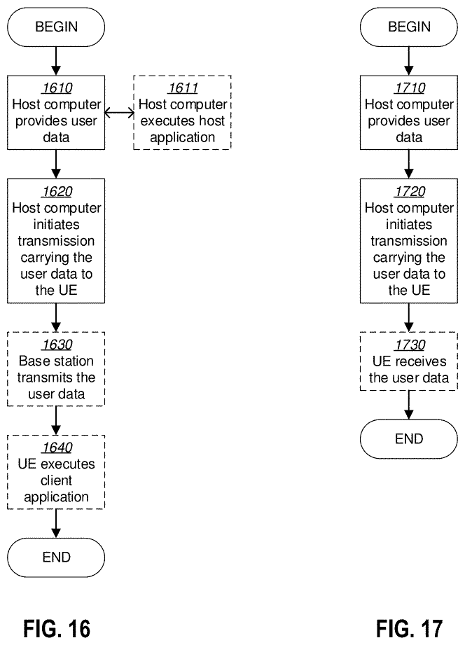

FIG. 16 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 16 will be included in this section. In a first step 1610 of the method, the host computer provides user data. In an optional substep 1611 of the first step 1610, the host computer provides the user data by executing a host application. In a second step 1620, the host computer initiates a transmission carrying the user data to the UE. In an optional third step 1630, the base station transmits to the UE the user data which was carried in the transmission that the host computer initiated, in accordance with the teachings of the embodiments described throughout this disclosure. In an optional fourth step 1640, the UE executes a client application associated with the host application executed by the host computer.

FIG. 17 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 17 will be included in this section. In a first step 1710 of the method, the host computer provides user data. In an optional substep (not shown) the host computer provides the user data by executing a host application. In a second step 1720, the host computer initiates a transmission carrying the user data to the UE. The transmission may pass via the base station, in accordance with the teachings of the embodiments described throughout this disclosure. In an optional third step 1730, the UE receives the user data carried in the transmission.

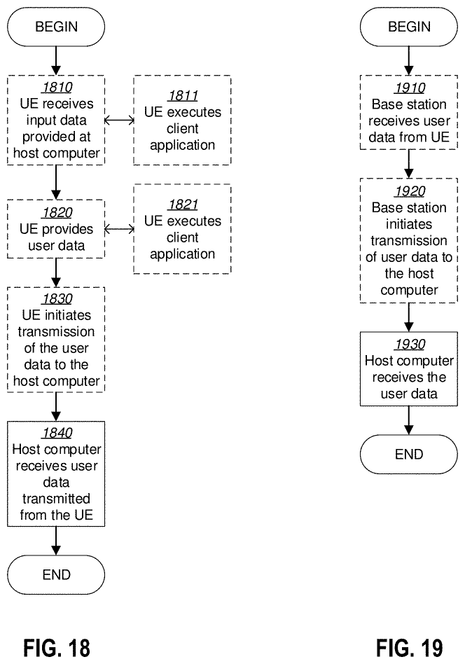

FIG. 18 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 18 will be included in this section. In an optional first step 1810 of the method, the UE receives input data provided by the host computer. Additionally or alternatively, in an optional second step 1820, the UE provides user data. In an optional substep 1821 of the second step 1820, the UE provides the user data by executing a client application. In a further optional substep 1811 of the first step 1810, the UE executes a client application which provides the user data in reaction to the received input data provided by the host computer. In providing the user data, the executed client application may further consider user input received from the user. Regardless of the specific manner in which the user data was provided, the UE initiates, in an optional third substep 1830, transmission of the user data to the host computer. In a fourth step 1840 of the method, the host computer receives the user data transmitted from the UE, in accordance with the teachings of the embodiments described throughout this disclosure.

FIG. 19 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 19 will be included in this section. In an optional first step 1910 of the method, in accordance with the teachings of the embodiments described throughout this disclosure, the base station receives user data from the UE. In an optional second step 1920, the base station initiates transmission of the received user data to the host computer. In a third step 1930, the host computer receives the user data carried in the transmission initiated by the base station.

The foregoing description of implementations provides illustration and description, but is not intended to be exhaustive or to limit the disclosure to the precise form disclosed. Modifications and variations are possible in light of the above teachings, or may be acquired from practice of the disclosure.

Aspects of the disclosure may also be embodied as methods and/or computer program products. Accordingly, the disclosure may be embodied in hardware and/or in hardware/software (including firmware, resident software, microcode, etc.). Furthermore, the embodiments may take the form of a computer program product on a computer-usable or computer-readable storage medium having computer-usable or computer-readable program code embodied in the medium for use by or in connection with an instruction execution system. Such instruction execution system may be implemented in a standalone or distributed manner. The actual software code or specialized control hardware used to implement embodiments described herein is not limiting of the disclosure. Thus, the operation and behavior of the aspects were described without reference to the specific software code, it being understood that those skilled in the art will be able to design software and control hardware to implement the aspects based on the description herein.

Furthermore, certain portions of the disclosure may be implemented as “logic” that performs one or more functions. This logic may include hardware, such as an application specific integrated circuit or field programmable gate array or a combination of hardware and software.

It should be emphasized that the term “comprises/comprising” when used in this specification is taken to specify the presence of stated features, integers, steps, components or groups but does not preclude the presence or addition of one or more other features, integers, steps, components or groups thereof.

No element, act, or instruction used in the disclosure should be construed as critical or essential to the disclosure unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

The foregoing description gives only the embodiments of the present disclosure and is not intended to limit the present disclosure in any way. Thus, any modification, substitution, improvement or like made within the spirit and principle of the present disclosure should be encompassed by the scope of the present disclosure.

1. A method performed at a first radio node, comprising:
determining whether to skip an uplink grant configured for a first link between the first radio node and a second radio node; and
in response to determining to skip the uplink grant, using a radio resource corresponding to the uplink grant on a second link.

2. The method of claim 1, wherein the radio resource corresponding to the uplink grant comprises at least one of: time resource, frequency resource, power resource and antenna resource.

3. The method of claim 1, further comprising, prior to using a resource corresponding to the uplink grant:
identifying whether the first radio node is enabled to use the radio resource corresponding to the uplink grant.

4. The method of claim 3, wherein the determining step is performed at least a predefined time period ahead of starting of a data transmission using the radio resource corresponding to the uplink grant or during a transmission duration of the uplink grant.

5. The method of claim 1, wherein using a radio resource corresponding to the uplink grant on a second link comprises:
scheduling the radio resource corresponding to the uplink grant for a data transmission between the first radio node and a third radio node connected to the first radio node.

6. The method of claim 5, wherein using a radio resource corresponding to the uplink grant on a second link further comprises:
performing the data transmission with the third radio node according to the scheduled radio resource.

7. The method of claim 6, wherein a maximum transmission power of the data transmission from the first radio node to the third radio node is either selected to not exceed the allowed maximum uplink transmission power of the first radio node to the second radio node, or preconfigured.

8. The method of claim 1, wherein using a radio resource corresponding to the uplink grant on a second link comprises:
transmitting an indication to a third radio node connected to the first radio node to indicate the radio resource corresponding to the uplink grant is available to the third radio node.

9. The method of claim 1, wherein the uplink grant is a configured uplink grant or a dynamically scheduled uplink grant.

10. The method of claim 1, wherein the first radio node is one of an Integrated Access Backhaul (IAB) node in an IAB network, a relay node, a base station (BS) and a device having a Device to Device (D2D) communication with another device.

11. A method performed at a third radio node, comprising:
for a data transmission between a first radio node connected to the third radio node and the third radio node, being scheduled by the first radio node regarding to a radio resource corresponding to an uplink grant which is configured for a first link between the first radio node and a second radio node and skipped by the first radio node; and
performing the data transmission with the first radio node according to the scheduled radio resource.

12. A method performed at a third radio node, comprising:
receiving an indication from a first radio node connected to the third radio node to indicate a radio resource corresponding to an uplink grant configured for a first link between the first radio node and a second radio node is available to the third radio node, wherein the uplink grant is skipped by the first radio node; and
scheduling the radio resource for a data transmission between the third radio node and a fourth radio node connected to the third radio node.

13. The method of claim 12, further comprising:
performing the data transmission with the fourth radio node according to the scheduled radio resource.

14. The method of claim 13, wherein a maximum transmission power of the data transmission from the third radio node to the fourth radio node is either selected to not exceed the allowed maximum uplink transmission power of the third radio node to the first radio node, or preconfigured.

15. The method of claim 12, further comprising, prior to scheduling the radio resource:
determining whether the radio resource is usable to the third radio node.

16. The method of claim 15, further comprising:
transmitting an indication to the fourth radio node, to indicate the radio resource is available to the fourth radio node.

17. The method of claim 12, wherein the radio resource corresponding to the uplink grant comprises at least one of: time resource, frequency resource, power resource and antenna resource.

18.-35. (canceled)
